(19) United States
(12) Patent Application Publication
(10) Pub. No.: US 2011/0085700 A1
(43) Pub. Date: Apr. 14, 2011

(54) Systems and Methods for Generating Bio-Sensory Metrics

(76) Inventor: Hans C. Lee, Carmel, CA (US)

(21) Appl. No.: 12/835,714

(22) Filed: Jul. 13, 2010

Related U.S. Application Data
(60) Provisional application No. 61/225,186, filed on Jul. 13, 2009.

(51) Int. Cl. G06K 9/00

(52) U.S. Cl. 382/103

(57) ABSTRACT

Neuromarketing processing systems and methods are described that provide marketers with a window into the mind of the consumer with a scientifically validated, quantitatively-based means of bio-sensory measurement. The neuromarketing processing system generates, from bio-sensory inputs, quantitative models of consumers' responses to information in the consumer environment, under an embodiment. The quantitative models provide information including consumers' emotion, engagement, cognition, and feelings. The information in the consumer environment includes advertising, packaging, in-store marketing, and online marketing.

### RELATED APPLICATION

This application claims the benefit of U.S. Patent Application No. 61/225,186, filed Jul. 13, 2009.

### TECHNICAL FIELD

The following disclosure relates generally to the collection and processing of data relating to bio-sensory metrics.

### BACKGROUND

Marketers have long desired a quantitative means for reliably gauging consumer response to their marketing efforts. Traditional methods such as surveys and focus groups have widely acknowledged limitations. The problem is that these approaches do not effectively capture Engagement and Emotion, the two most critical drivers of purchase impact. Moreover, conventional methods suffer from the need to rely upon the consumer's ability, or inability, to accurately explain reactions, feelings and preferences.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 is a block diagram of a neuromarketing processing system that generates, from bio-sensory inputs, quantitative models of consumers' responses to information in the consumer environment, under an embodiment.

FIG. 2 shows an eye-tracking example, under an embodiment.

FIG. 3 shows a cognitive overlay example, under an embodiment.

FIG. 4 shows an emotional overlay example, under an embodiment.

FIG. 5 is an example Shopper Purchase Profile™, under an embodiment.

FIG. 6 is an example Shopper Purchase Funnel™, under an embodiment.

FIG. 7 is an example Consideration Cluster™, under an embodiment.

FIG. 8 is an example of product fixation, emotion, and cognition mapping, under an embodiment.

FIG. 9 is a flow diagram for automatically segmenting video data of subjects 900, under an embodiment.

FIG. 10 is an example of Optical Flow Subtraction Increasing Accuracy of Velocity-Based Fixation Assignment, under an embodiment.

FIG. 11 is an example of Optical Flow Subtraction, under an embodiment.

FIG. 12 shows an example user interface for tagging, under an embodiment.

FIG. 13 is an example graphical user interface (GUI) of the AOI Designer, under an embodiment.

FIG. 14 is an example Auto Event Tagger graphical user interface (GUI), under an embodiment.

FIG. 15 is an example Purchase Funnel™, under an embodiment.

### DETAILED DESCRIPTION

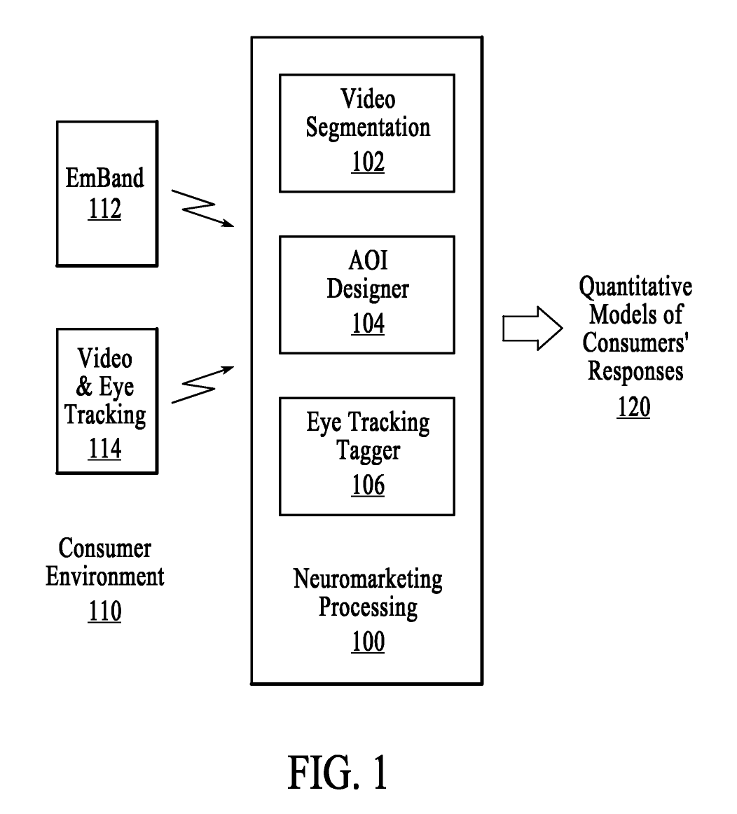

Systems and methods described herein provide marketers with a window into the mind of the consumer with a scientifically validated, quantitatively-based means of bio-sensory measurement. FIG. 1 is a block diagram of a neuromarketing processing system that generates, from bio-sensory inputs, quantitative models of consumers' responses to information in the consumer environment, under an embodiment. The quantitative models provide information including, but not limited to, consumers' emotion, engagement, cognition, and feelings, to name a few. The information in the consumer environment includes, but is not limited to, advertising, packaging, in-store marketing, and online marketing, for example.

In the following description, numerous specific details are introduced to provide a thorough understanding of, and enabling description for, embodiments of the systems and methods. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

Marketers have long desired a quantitative means for reliably gauging consumer response to their marketing efforts. Traditional methods such as surveys and focus groups have widely acknowledged limitations. The problem is that these approaches do not effectively capture Engagement and Emotion, the two most critical drivers of purchase impact. Moreover, traditional methods suffer from the need to rely upon the consumer's ability—or inability—to accurately explain reactions, feelings and preferences. The embodiments described herein provide marketers with a window into the mind of the consumer with a scientifically validated, quantitatively based means of bio-sensory measurement.

Using the tools of an embodiment, for the first time, marketers and market researchers can gain direct access to consumers' Cognitive Engagement and Emotional Responses to advertising, packaging, in-store and online marketing. This is made possible through the EmBand™, a scalable, non-invasive physiological and brainwave measurement technology configured specifically for market research. The EmBand™ provides quantitative metrics and insights that assist marketers in optimizing campaign strategy and tactics. Moreover, the EmBand™ is completely comfortable for consumers to wear and non-biasing to research. The portability and ease-of-use of the EmBand™ enables robust sample sizes, insuring statistical validity and real-world actionability of results. With global deployment capability, quantitative samples, test/re-test reliability, scientific credibility, and the largest database of bio-sensory norms in the world, the embodiments deliver insights that can positively impact Marketing ROI.

The embodiments described herein provide bio-sensory metrics to marketers and content makers in a form that is relevant, statistically valid and actionable. The embodiments include headsets that combine neuroscience and other bio-sensory inputs to create a robust model of human response. This model is used to track feelings, measure cognition, profile engagement, and maximize return on investment in marketing. The embodiments provide unobtrusive data collection through the use of portable, dry, wireless EEG, measuring emotional response and cognitive thought. The embodiments also provide statistically robust sample sizes, intuitive metrics and reporting, and a 360° measurement or view of the consumer by including a suite of tools that provide breakthrough insight into your brand impact at every consumer touchpoint. The 360° measurement provides breakthrough insight into brand impact at each consumer touchpoint through advertising testing, package/concept testing, virtual in-store testing, in-store testing, and online testing to name a few.

In the field of advertising testing, the embodiments include EmBand™ bio-sensory measurements, diagnostic questionnaire, quantitative sample sizes (150+) and the largest normative bio-sensory database. These tools deliver the following, but the embodiment is not so limited: Five Key Indicators of Efficacy™—for normative performance evaluations; Scene Study Diagnostics™—links individual scenes with bio-sensory responses; BrandScape™—identifies the power of branding. The advertising testing of an embodiment offers a new depth of understanding for advertising measurement by delivering the most comprehensive measurement of how communications impact consumers and specifically, what can be improved to turn an average advertisement into a top performer. The EmBand™ provides feedback on an advertisement's characters, music, voiceovers, product demonstrations—virtually any specific ad element.

The embodiments offer a breakthrough in the understanding of how television and all three hundred sixty degree advertising impacts consumers through brainwave and physiological response patterns. Zeroing in on the most critical aspects of advertising response—Cognitive Engagement and Emotion—the embodiments provide quantitative guidance for evaluating and optimizing the impact of advertising on an audience. The embodiments deliver the most comprehensive measurement of how communications impact consumers and specifically, what can be improved to turn an average advertisement into a top performer. The EmBand™ provides specific feedback on an advertisement's characters, music, voiceovers, product demos—virtually any specific ad element.

Key features of advertising testing of an embodiment include, but are not limited to, the following: wireless, unobtrusive, EmBand™ headset; measures Positive/Negative Emotion and Cognitive Engagement; broad normative database; 150,000+ ad views; “Uber Norms” includes two years of Cannes & Effie winners; quantitative sample sizes; n=150+; test/re-test validity; test both finished and unfinished ad copy; custom and omnibus tests; sub-group analysis; eye tracking for print, outdoor, Internet, P-O-P , etc.

In the field of package/concept testing, the embodiments include EmBand™ bio-sensory measurements, diagnostic questionnaire, quantitative sample sizes (150+) and eye tracking. These tools deliver the following, but the embodiment is not so limited: Speed of Attraction, Holding Power, Viewing Intensity, Cognition Intensity, Emotion Intensity. The concept and package testing offers package response measurement through use of a quantitative method for understanding how concepts are processed, when and how packaging is noticed and how that viewing engages and impacts shoppers. An embodiment overlays bio-sensory data for cognition and emotion onto state-of-the-art eye tracking, linking each package or concept element viewed with the target's corresponding visceral reactions.

The quantitative method of an embodiment provides an understanding of when and how packaging is noticed and how that viewing engages and impacts shoppers. The embodiment overlays bio-sensory data for cognition and emotion onto eye tracking information or data, linking each element viewed with the shoppers' corresponding visceral reactions. Bio-sensory responses are further evaluated in the context of purchase behavior and purchase intent, along with standard and custom diagnostic measures.

The tools of an embodiment can test packaging in all forms—rough drawings, photographic images, prototype mock-ups, etc.—and in both stand-alone and category context—simulated shelf placement, actual in-store shopping, virtual store simulations and package usage experience.

Key features of package/concept testing of an embodiment include, but are not limited to, the following: wireless, unobtrusive, EmBand™ headset; measures Positive/Negative Emotion and Cognitive Engagement; quantitative sample sizes; n=150+; includes stationary or mobile eye tracking.

The concept and package testing provides the following information, but is not so limited: Speed of Attraction—how quickly is package noted on shelf; Holding Power—how long does package hold shopper's attention; Viewing Intensity—where do eyes fixate on package, and for how long; Cognition Intensity—which elements of package trigger active thought; Emotion Intensity—how does package impact emotions; Is there an immediate visceral reaction to package; Which elements of the package engage, repel or are ignored (missed); Are key claims on package engaging and noted; Standard and custom survey diagnostics; Comparison of performance versus competition.

In the field of virtual and live in-store testing, the embodiments include EmBand™ bio-sensory measurements, diagnostic questionnaire, quantitative sample sizes (100+) and mobile eye tracking. These tools deliver the following, but the embodiment is not so limited: Shopper Purchase Profile™, Purchase Funnel™, Consideration Cluster™, Purchase Decision Model. The in-store testing uncovers bio-sensory drivers of purchase using a scalable neuroscience approach that allows shoppers' emotional and cognitive response to be quantitatively measured in their natural shopping state, enabling marketers to know how shoppers respond to their brand at each stage of the retail shopping experience. With the in-store research, marketers can understand the visceral drivers of purchase or rejection. The embodiments capture the emotional and cognitive engagement of shoppers as they maneuver through store aisles, encounter signage and POS, engage with store personnel, scan categories, examine packages and make purchase decisions.

The in-store testing of an embodiment offers a scalable neuroscience approach that allows shoppers' emotional and cognitive response to be quantitatively measured in their natural shopping state, enabling marketers to know how shoppers respond to their brand at each stage of the retail shopping experience. With this In-Store research, marketers can understand the visceral drivers of purchase or rejection. The embodiment captures the emotional and cognitive engagement of shoppers as they maneuver through store aisles, encounter signage and POS, engage with store personnel, scan categories, examine packages and make purchase decisions. The embodiment incorporates mobile eye-tracking to enable a true “free roaming” shopper experience.

The embodiments bring neuroscience to shopper insights using in-store testing that tracks feeling, eye movement, cognition, and engagement. This provides a scalable neuroscience approach that allows shoppers' emotional and cognitive responses to be quantitatively measured in their natural shopping state. As described above, FIG. 1 is a block diagram of a neuromarketing processing system 100 that generates, from bio-sensory inputs, quantitative models 120 of consumers' responses to information in the consumer environment 110, under an embodiment. The quantitative models 120 provide information including, but not limited to, consumers' emotion, engagement, cognition, and feelings, to name a few. The information in the consumer environment 110 includes, but is not limited to, advertising, packaging, in-store marketing, and online marketing, for example.

The neuromarketing processing system 100 receives data from a consumer environment 110 via data collection devices. The data collection devices of an embodiment include the EmBand™ headset 112, which is worn by consumers in the environment, and/or a video and eye tracking component or system 114. The data from the data collection devices serves as the input to the neuromarketing processing system 100. The data can be transferred from the data collection devices to the neuromarketing processing system 100 via any of a variety of wireless and/or wired couplings or connections and/or any of a variety of network types. The neuromarketing processing system 100 includes at least one processor (not shown) and at least one database (not shown). The neuromarketing processing system of an embodiment includes a video segmentation component or system 102 running under and/or coupled to the processor. The neuromarketing processing system 100 of an embodiment includes an area of interest (AOI) component or system 104 running under and/or coupled to the processor. The neuromarketing processing system 100 of an embodiment includes an eye tracking tagger component or system 106 running under and/or coupled to the processor. Each of the video segmentation system 102, AOI system 104, and eye tracking tagger system 106 is described in detail below. The neuromarketing processing system processes the data from the data collection devices and generates quantitative models of consumer response 120, as described in detail below.

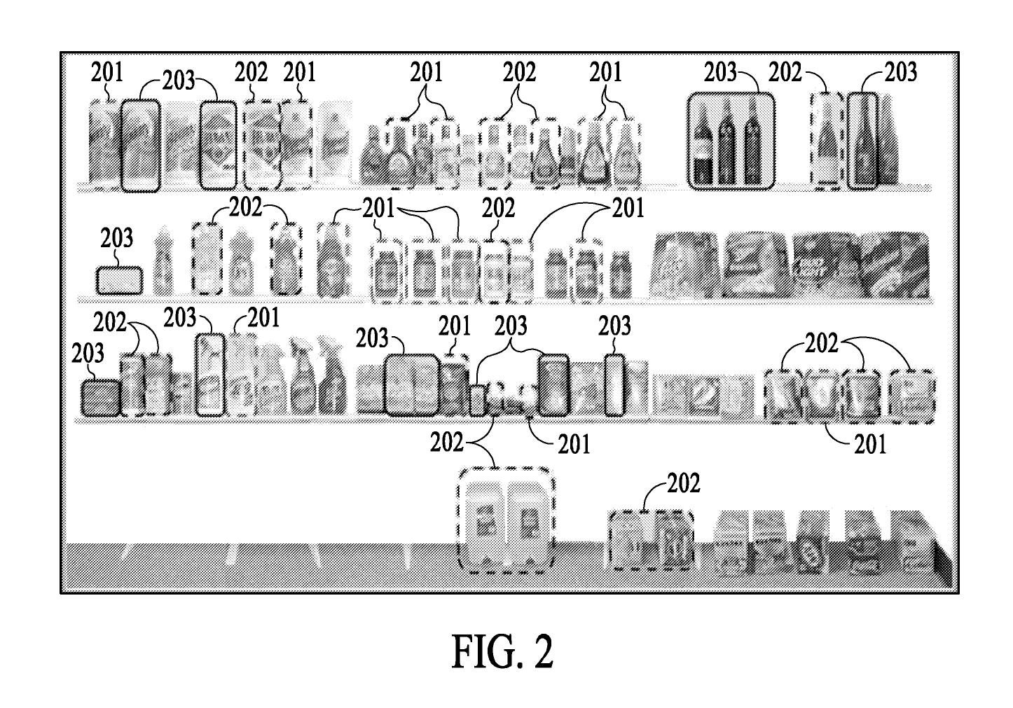

The quantitative models of consumer response 120 of an embodiment include eye-tracking data showing where a consumer is looking in the environment. FIG. 2 shows an eye-tracking example, under an embodiment. In this example, a product display is presented via a user interface as it was viewed by the consumer in the consumer environment. For this product display, products are represented by objects in the display and data from one or more data collection devices is used to provide an indication of a type of view detected by the consumer and corresponding to the product. The user interface, for example, might display an object with a broken line border (first color) 201 around the object to represent a first type of consumer view (e.g., view of a first duration) of the product. Similarly, the user interface might display an object with a broken line border (second color) 202 around the object to represent a second type of consumer view (e.g., view of a second duration) of the product. Also, the user interface might display an object with a solid line border 203 around the object to represent a third type of consumer view (e.g., view of a third duration) of the product. The user interface might display an object absent a border around the object to represent a failure by the consumer to view the product.

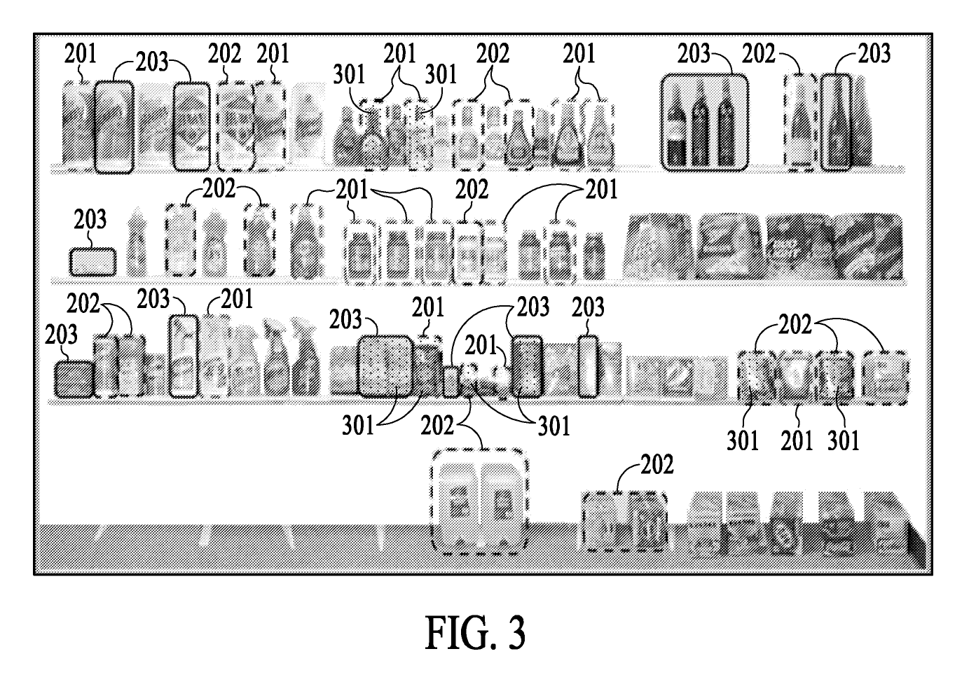

The quantitative models of consumer response 120 of an embodiment include a cognitive overlay that shows what the consumer thought about products in the consumer environment. The cognitive overlay enables marketers to know how their target shopper responds to their brand and to the retail environment during each step of the purchase process. FIG. 3 shows a cognitive overlay example, under an embodiment. In this example, a product display is presented via a user interface as it was viewed by the consumer in the consumer environment. The products are represented by objects in the display and data from one or more data collection devices is used to provide an indication of a type of view (201-203) detected by the consumer and corresponding to the product, as described above. Moreover, data from one or more data collection devices is used to provide bio-sensory data of consumer cognition corresponding to some or all of the products. The user interface, for example, might display an object with a color-coded overlay 301 in the border around the object to represent a consumer thought corresponding to the product.

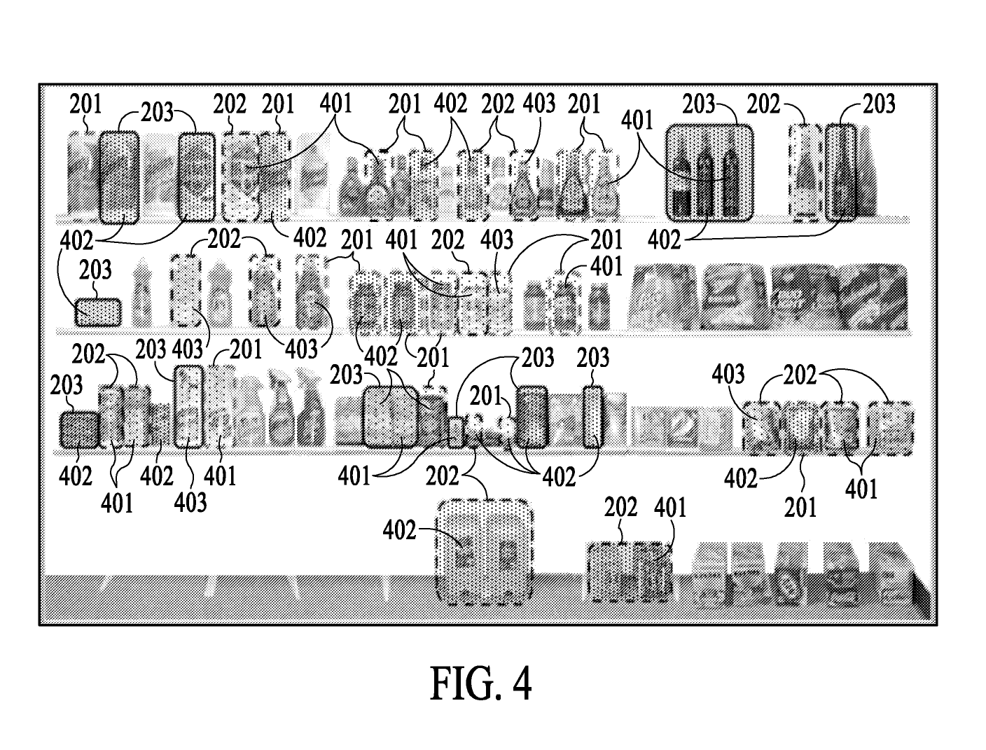

The quantitative models of consumer response 120 of an embodiment include an emotional overlay that shows how the consumer felt about products in the consumer environment. The emotional overlay provides marketers with data of how a consumer felt about a product, which maximizes shopper marketing ROI by providing an in-depth understanding of a brand's strengths and opportunities at retail, providing actionable insight to brand managers and retailers. FIG. 4 shows an emotional overlay example, under an embodiment. In this example, a product display is presented via a user interface as it was viewed by the consumer in the consumer environment. The products are represented by objects in the display and data from one or more data collection devices is used to provide an indication of a type of view (201-203) detected by the consumer and corresponding to the product, as described above. Moreover, data from one or more data collection devices is used to provide bio-sensory data of consumer emotion corresponding to some or all of the products. The user interface, for example, might display an object with a color-coded overlay in the border around the object to represent a consumer emotion corresponding to the product. For example, a first color overlay (e.g., green) 401 indicates a first emotion while a second color overlay (e.g., red) 402 indicates a second emotion and a third color overlay (e.g., gray) 403 indicates a third emotion.

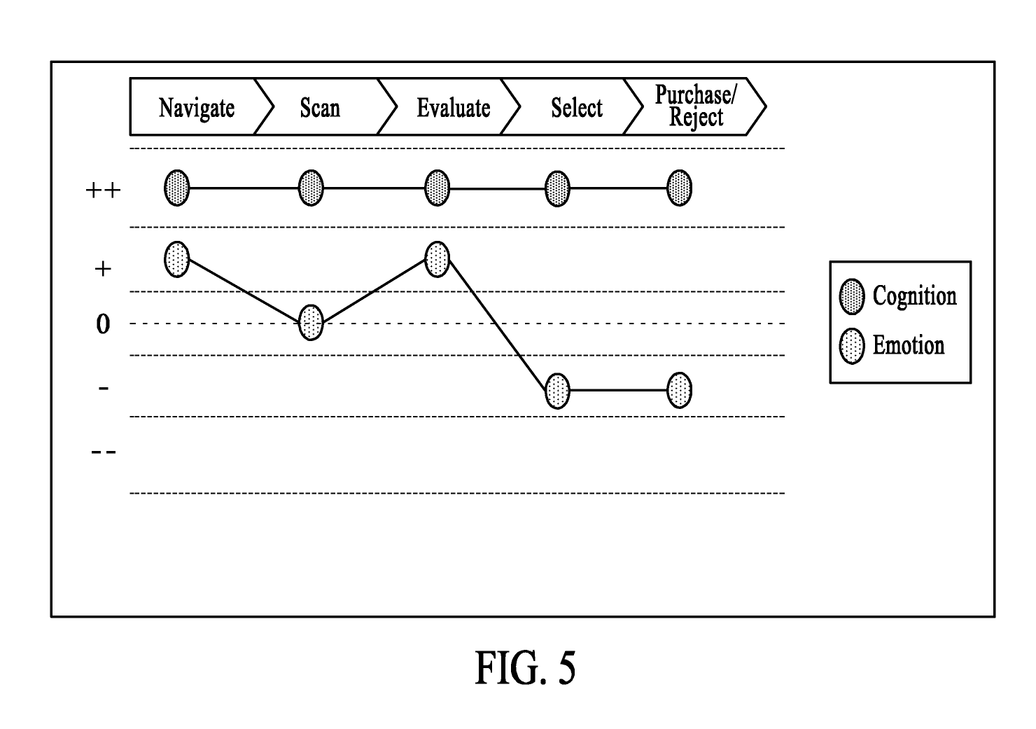

The in-store testing includes a Shopper Purchase Profile™ that provides information as to how shoppers feel at each phase of the shopping journey. FIG. 5 is an example Shopper Purchase Profile™, under an embodiment. This profile, for example, shows quantitative information on cognition and emotion for each phase (e.g., navigate, scan, evaluate, select, purchase/reject) of the shopping journey.

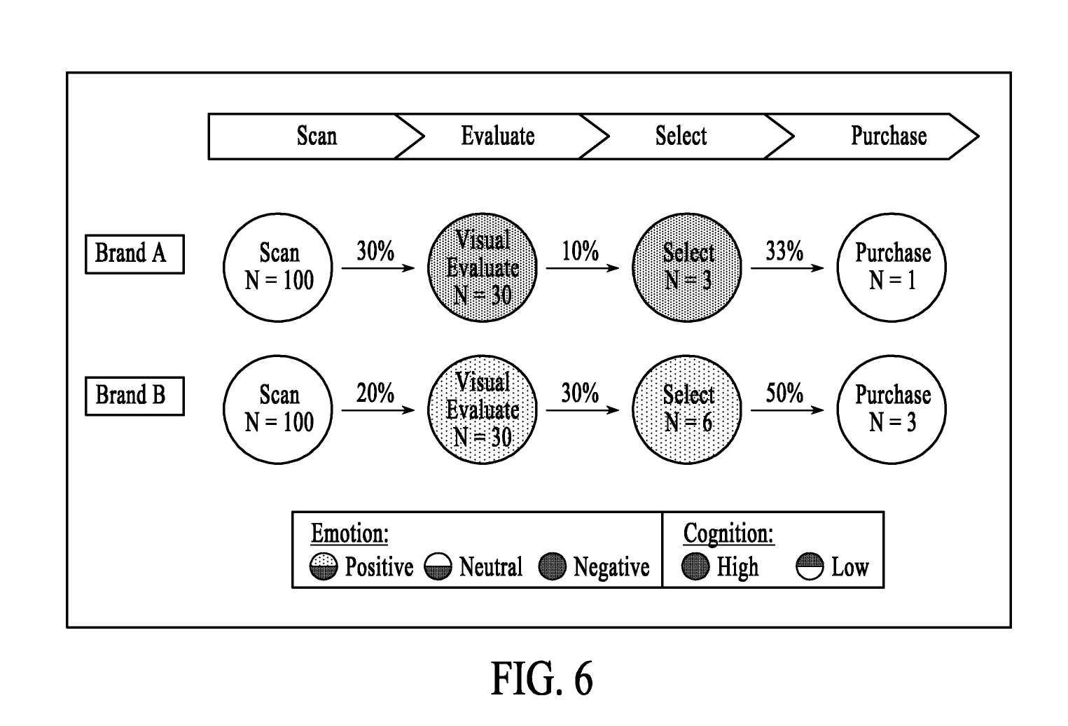

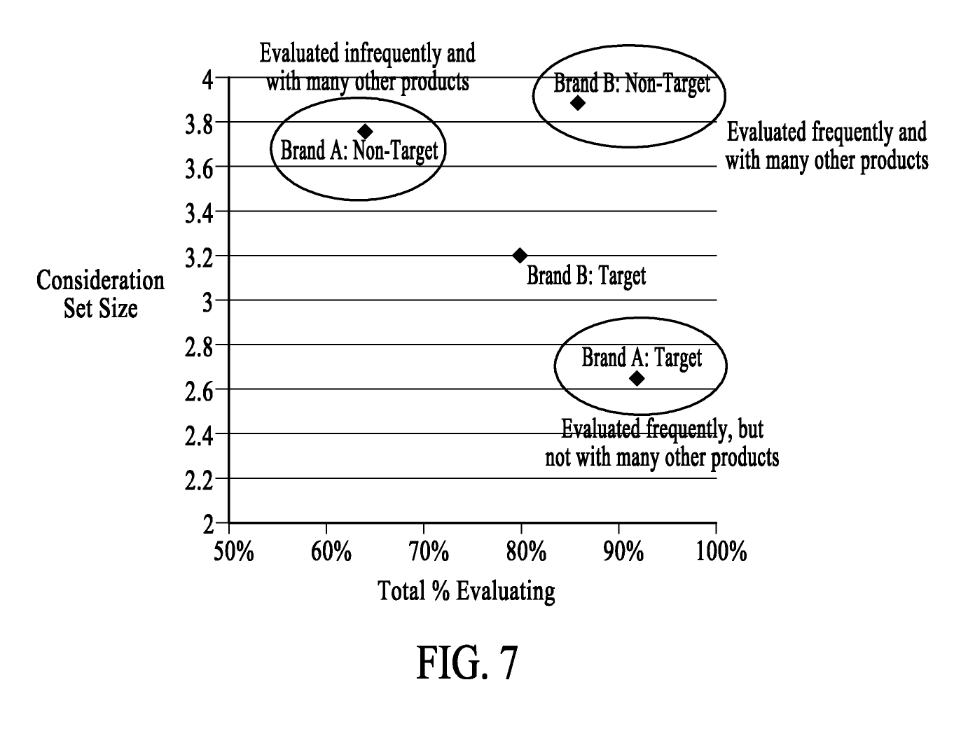

The in-store testing includes a Shopper Purchase Funnel™ that provides information as to how shoppers behave, and which neurometric profiles correspond to a purchase. FIG. 6 is an example Shopper Purchase Funnel™, under an embodiment. The funnel shows, for example, profiles for each of Brand A and Brand B for shopping phases (e.g., scan, evaluate, select, purchase). In this example, the funnel data indicates that, for Brand A, the scan and purchase phases elicited generally positive emotion and generally low cognition, while the visual evaluation and selection phases elicited generally negative emotion and generally high cognition. The funnel data indicates that, for Brand B, the scan phase elicited generally neutral tending to slight positive emotion while the purchase phase elicited generally positive emotion. Both the scan and purchase phases elicited generally low cognition. Continuing for Brand B, the visual evaluation and selection phases elicited generally positive emotion and generally high cognition. The in-store testing includes a Consideration Cluster™ that provides information as to which products are in a shopper's consideration set and which are not in a shopper's consideration set. FIG. 7 is an example Consideration Cluster™, under an embodiment. This quantitative information plots consideration set size against the total percentage evaluating.

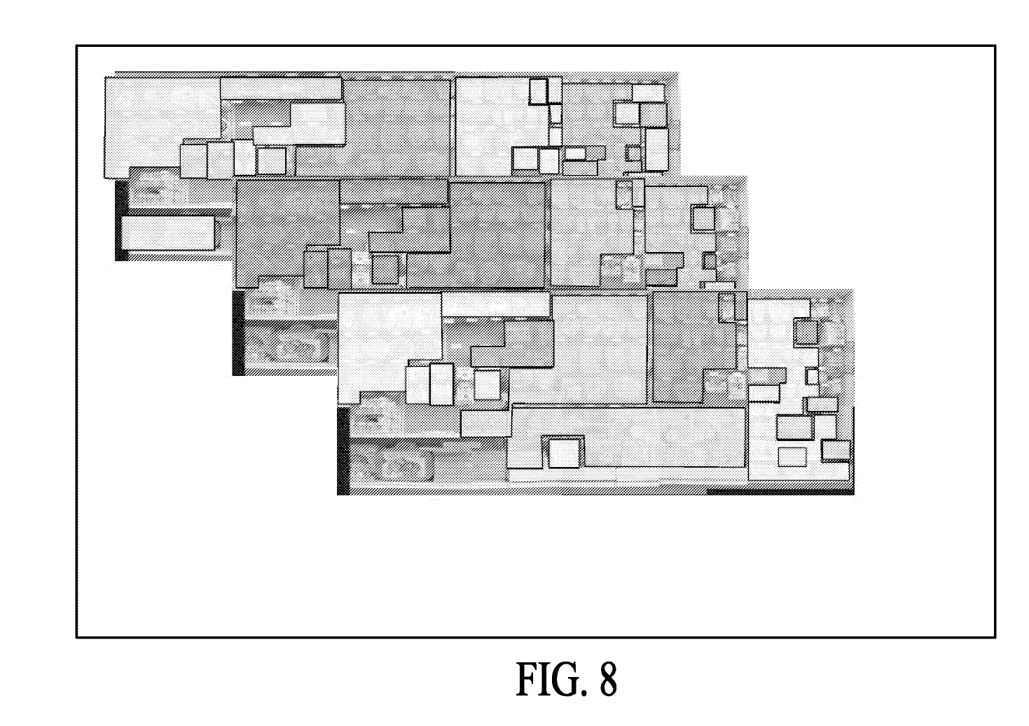

The in-store testing includes product fixation, emotion, and cognition mapping that provide information as to what shoppers look at, for how long, and how they respond. FIG. 8 is an example of product fixation, emotion, and cognition mapping, under an embodiment.

The Shopper Purchase Profile™ and the Purchase Funnel™ decision models identify how shopper response corresponds to the success or failure of a product or category at retail. The In-store research provides an in-depth understanding of a product or category's strengths and opportunities at retail, providing actionable insight to brand managers and retailers alike.

Offered in both live in-store and virtual store environments, the technology of an embodiment provides the portability, ease-of-use, and sensitivity to measure the emotional and cognitive engagement that shoppers experience in-store, providing marketers the insights needed to maximize the ROI of their shopper marketing initiatives.

Key features of in-store testing of an embodiment include, but are not limited to, the following: wireless, unobtrusive, EmBand™ headset; measures Positive/Negative Emotion & Cognitive Engagement; quantitative sample sizes; n=100₊; any category, class of trade, or market; experience Tracking™: Fast turnaround from field to insight; Mobile eye-tracking glasses (live in-store); Small POV camera (live in-store); Optional audio (live in-store); Virtual store environment (virtual in-store); Stationary Eye tracking (virtual in-store).

The in-store testing provides the following information, but is not so limited: Shopper Purchase Profile™—how does the shopper feel throughout the shopping journey; Purchase Funnel™—how do shoppers behave? Why do they abandon the purchase process; Consideration Cluster™—which products are in your shopper's consideration set? Which are not; Purchase Decision Model—which products are most and least effective at converting purchases; Brand-Experience—how does the shoppers' experience with your brand compare to competition; Product fixations, emotion/cognition maps—what do shoppers look at, for how long, and how do they respond; Standard and custom survey diagnostics.

In the field of online testing, or web testing, the embodiments include EmBand™ bio-sensory measurements, diagnostic questionnaire, quantitative sample sizes (100+) and eye tracking. These tools deliver the following, but the embodiment is not so limited: Areas of Interest (AOI's), Cognition Intensity, Emotion Intensity. The web testing of an embodiment drives immersive online experiences through the use of a cutting-edge quantitative method for precisely understanding where users are looking on a web page and their corresponding emotional and cognitive responses. With granular insight into the details of every page—how the site engages the user, evokes positive emotion, and steers the user towards the desired behavior—this approach enables the optimization of the user experience.

In online testing, the embodiments provide a quantitative method for precisely understanding where users are looking on a web page and their corresponding emotional and cognitive responses. The embodiment integrates bio-sensory data for cognition and emotion with state-of-the-art eye tracking, linking each element of a web-site viewed with the viewers' corresponding visceral reactions. Bio-sensory responses are further evaluated in the context of specific tasks. The embodiment can test various types of websites for usability, engagement, purchase behavior and advertisement effectiveness.

Key features of online testing of an embodiment include, but are not limited to, the following: wireless, unobtrusive, EmBand™ headset; Measures Positive/Negative Emotion and Cognitive Engagement; Stationary eye tracking; Quantitative sample sizes; n=100+.

The online testing provides the following information, but is not so limited: Areas of Interest (AOI's)—where specifically do a website's users spend time looking; Cognition Intensity—which elements of the website engage viewers in active thought; Emotion Intensity—which areas of the site elicit positive/negative emotions; What tasks are easily completed or difficult to do; Which areas of the website present a barrier to purchase and/or where do users drop out; Standard and custom survey diagnostics; Comparison of performance versus competition.

An embodiment includes game testing that provides information of tracked and measured player responses to game developers and marketers. With insights into numerous details—how a game drives engagement, provokes positive emotion, elicits cognitive responses, and gets adrenaline pumping—a game developer can identify the most exciting features, optimize emotions and flow, refine level designs, emphasize best mechanics, and craft a storyline for maximum engagement—with robust results on key game play.

The Experience Management also tracks comparable titles in all the major genres, including: First Person Shooters, Action/Adventure, Racing, Sports, RPG, and more. Now you can know how your audience experiences your game, and your competition's, inside and out.

Key features of an embodiment include, but are not limited to, the following: wireless, unobtrusive, EmBand™ headset; Measures of Arousal, Positive/Negative Emotion and Cognitive Engagement; large normative database; 100+games tested; competitive title benchmarking; non-invasive and comfortable.

The video game testing provides the following information, but is not so limited: Total experience rank; Level profiles; Feature performance; Standard and custom survey diagnostics; Comparison of performance versus competition.

Aspects of the systems and methods of an embodiment are described in detail below.

### Video Segmentation Based On Optical Flow-Corrected Fixation Data

In the field of marketing research, it is common to collect video and eye tracking data of consumers as they navigate through a store, shopping and making purchasing decisions. As a consumer browses through a store, monitoring their gaze with eye tracking hardware provides an initial estimate as to when their visual attention is attracted by objects in the shopping environment. Periods of time when the consumer is looking at one object for more than 100 milliseconds are termed “fixations,” as the consumer's visual attention is focused, or fixated, on that object. A current limitation to this research methodology is that the videos are segmented by hand into temporal regions of interest (ROIs); for example, it is interesting to know when a consumer is standing and looking at a shelf as opposed to moving through an aisle. This “event tagging” process is typically done on the videos in a frame-by-frame manner, where researchers sit and click through each frame of the videos to tag relevant events. This process can easily require several hours for every 10 minutes of video time, in order to insure that tags are appropriately set for further analysis.

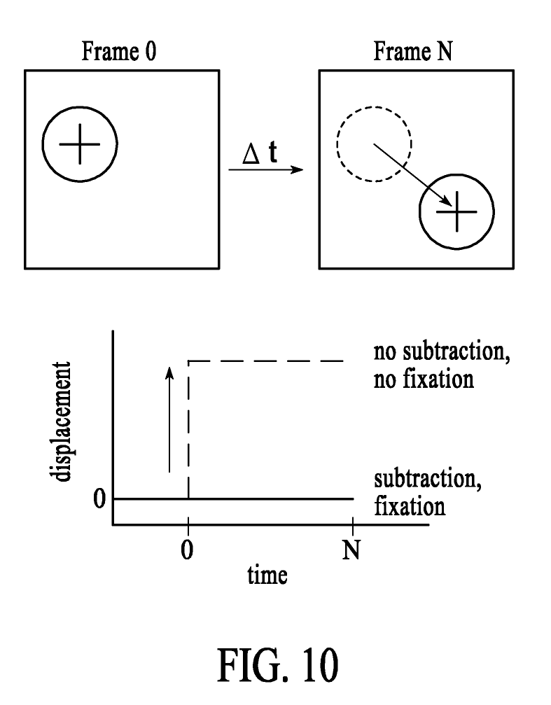

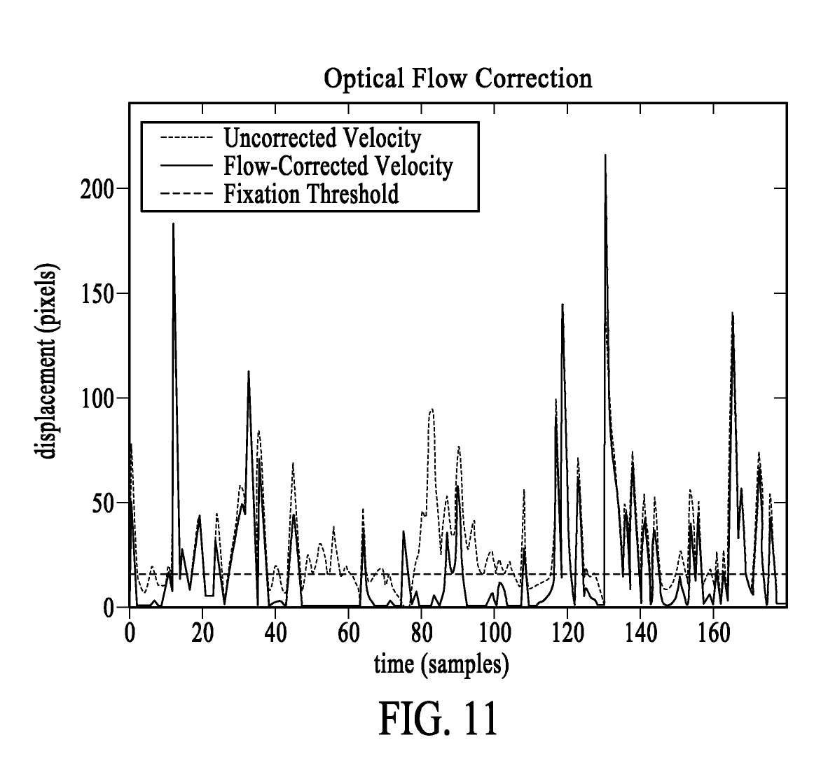

As described above, the neuromarketing processing system 100 of an embodiment includes a video segmentation component or system 102. The video segmentation combines traditional gaze velocity data from an eye tracking device with cross correlation-based optical flow subtraction to dramatically improve the efficiency of this video tagging process. Fixations are computationally defined as periods of time during which the gaze displacement, or velocity, does not exceed a threshold value. These fixations can be considered as functional regions of interest for event tagging. This gaze velocity measurement alone, however, fails when the subject is tracking something that is moving across their visual field (see FIG. 10). In order to improve the accuracy of ROIs defined from this type of fixation data, the rate of object movement across the visual field (or, the “optical flow”) can be subtracted from the gaze velocity (see FIG. 11). By pre-defining ROIs based on flow-subtracted gaze fixations, the time required for effective event tagging can be reduced by as much as 20 times. This increased efficiency permits larger sample sizes to be analyzed in less time, adding both value and statistical certainty to this type of analysis. In addition to improved efficiency, the method increases the accuracy of video segmentation, basing ROIs on a quantitative measure of visual engagement, independent of whether or not the object of interest is moving in the participant's visual field. Once these ROIs are computationally defined, the ROI data can then be loaded into “event editor” software that allows researchers to further refine the tags by inserting relevant metadata for subsequent analysis.

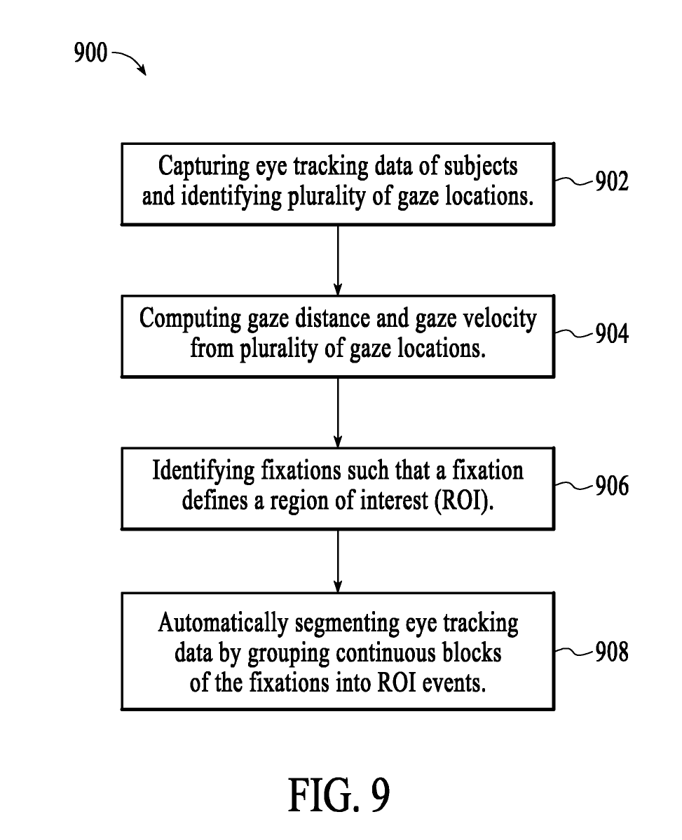

Generally, FIG. 9 is a flow diagram for automatically segmenting video data of subjects 900, under an embodiment. The method of an embodiment comprises capturing eye tracking data of subjects and identifying a plurality of gaze locations 902. The method comprises computing a gaze distance and a gaze velocity from the plurality of gaze locations 904. The method comprises identifying fixations 906. A fixation defines a region of interest (ROI). The method comprises automatically segmenting the eye tracking data by grouping continuous blocks of the fixations into ROI events 908.

More specifically, FIG. 10 is an example of Optical Flow Subtraction Increasing Accuracy of Velocity-Based Fixation Assignment, under an embodiment. Visual tracking of a moving object creates large gaze velocity (displacement) values. In the example above, the tester is fixated on the circle (as indicated by the plus sign) as it moves from top-left to bottom-right over some period of time (denoted At). This motion is recorded as a large constant velocity by the eye tracking hardware, which would result in this visual tracking not being counted as a fixation (dotted line in the displacement plot). Taking into account the optical flow during this time, or the rate at which the circle is moving, results in proper assignment of a fixation (solid line in the displacement plot).

FIG. 11 is an example of Optical Flow Subtraction, under an embodiment. The uncorrected velocity vector (dashed line) shows two periods of time during which high optical flow prevents proper identification of fixations (between about 50-60 samples, and 80-100 samples). Subtracting optical flow (solid line) results in these time periods being correctly identified as fixations.

The method of an embodiment includes, but is not limited to, the following process. The method computes a “velocity vector” from eye tracking gaze coordinates. The method selects a video frame (“frame0”) and a next video frame (“frame1”). The method extracts a correlation window (“CorWin”) from frame1. The method computes a normalized two-dimensional cross correlation between CorWin and frame0. The method identifies the location of global correlation maximum (“CorMax”). The method defines “optical flow” as the distance between gaze location in frame0 and CorMax. The method repeats the preceding processes through the length of the video. The method subtracts the optical flow from velocity vector. The method defines ROIs based on flow-subtracted fixations. The method writes ROIs to a text file. The method loads the ROI file in “event editor” software for metadata tag refinement.

The embodiments described above include a method of automatically segmenting market research (e.g., consumer-perspective) video data into regions of interest (ROIs) based on eye tracking gaze velocity. The method of an embodiment comprises recording gaze location as (x,y) coordinate pairs in a machine-readable text file. The method of an embodiment comprises computing the distance between consecutive pairs of coordinates. The method of an embodiment comprises computing the time derivative of the distances as a gaze velocity vector. The method of an embodiment comprises empirically setting a threshold velocity for defining fixations based on the distribution of distances. The method of an embodiment comprises grouping continuous blocks of fixations into ROI events that are written to a machine-readable text file. The method of an embodiment comprises reading the event file into a graphical user interface software package for refined metadata tag completion.

The gaze velocity vector of an embodiment is corrected for optical flow with a method comprising computing normalized cross correlation between consecutive video frames. The gaze velocity vector of an embodiment is corrected for optical flow with a method comprising identifying (x,y) coordinate of the global maximum of the correlation output. The gaze velocity vector of an embodiment is corrected for optical flow with a method comprising defining optical flow vector as the distance between correlation peak coordinates from consecutive frames. The gaze velocity vector of an embodiment is corrected for optical flow with a method comprising subtracting optical flow from gaze velocity.

The cross correlation of an embodiment is computed in small rectangular windows, centered around the (x,y) coordinates of the gaze vector.

Video frames of an embodiment are read into memory in large blocks.

Image frames of an embodiment are downsampled by a constant factor.

A constant number of frames of an embodiment is skipped for the optical flow calculation, and then filled in by linear interpolation.

The tagging of an embodiment is further refined by including data about a consumer's location and body position within the shopping environment.

Converting Time and Image Based Data into Position Data on a Reference Object Across a Population of Samples

One challenge faced is aggregating data from the real world to break or segment video of a person interacting with the environment into a set of comparable events between a set of people. The key challenge has been to be able to “tag” or evaluate each place they look or move efficiently. Because a resolution of ˜100 msec is needed for correlating a person with what they are looking at, this means that for one participant looking around for ten minutes, it would take writing down 6,000 independent notes. When this is done across 100 people, this becomes 600,000 notes, which may take weeks to do. In addition, the complexity of the notes goes up with the complexity of the environment, so while it may be easy to tag if a person in an empty room is looking at the one red cube or not, it is very difficult to differentiate one pair of shoes from up to 1,000 almost identical shoes that are on a wall at a large department store. This means that to tag this by hand may take up to 10 seconds per shoe, leading to 100,000 minutes of tagging or 1,700 hours of tagging, which is roughly 10 man-months. This is too much time for a company to use a service to test a product or other item.

The neuromarketing processing system 100 of an embodiment includes an eye tracking tagger component or system 106 running under and/or coupled to the processor. The tagger can tag the data in near real-time, and is based on the auto-fixation tagging described herein plus a “Graphical Area of Interest Tagger” application.

The key issues in tagging include complexity of a scene that leads to difficulties in a person differentiating what is being looked at, and time resolution necessary to differentiate eye tracking is 100 msec minimum, leading to a large number of samples.

The system of an embodiment uses auto-fixation tagging to lower the number of elements that must be selected by many times over the calculation above. This is realized by analyzing the motion of the eye on an eye tracker combined with the motion of the head—relative to the scene—to see where the person changed what they were looking at. This system analyzes if there was a relevant change in what was looked at or viewed. If not, it lumps the whole time segment into a “Fixation”. Fixations can range from approximately 0.1 second to sometimes up to 1.5 or more seconds. This means that only when a new area is looked at is the person who is tagging the data notified.

The second challenge is identifying what the participant is looking at. If there are 100 white shoes, it is difficult to remember that #14 is from a specific brand and has a type. It is easy, however, to know that it is shoe #14 by counting. The system of an embodiment uses a graphic chooser to have the tagger click on the location seen in the video for each fixation. The tagger can have a set of images that represent the objects in the scene. These can be shelves, products, people, floor layouts, etc. When a fixation is shown by the software, a marker is placed on the video in the location where the participant is looking. The tagger then looks at the video and clicks on the correct object and the correct location on the object where the person is looking. The software will then advance to the next fixation automatically. This takes what was a 10 second process per tag and makes it into a 0.1 to a 0.5 second process.

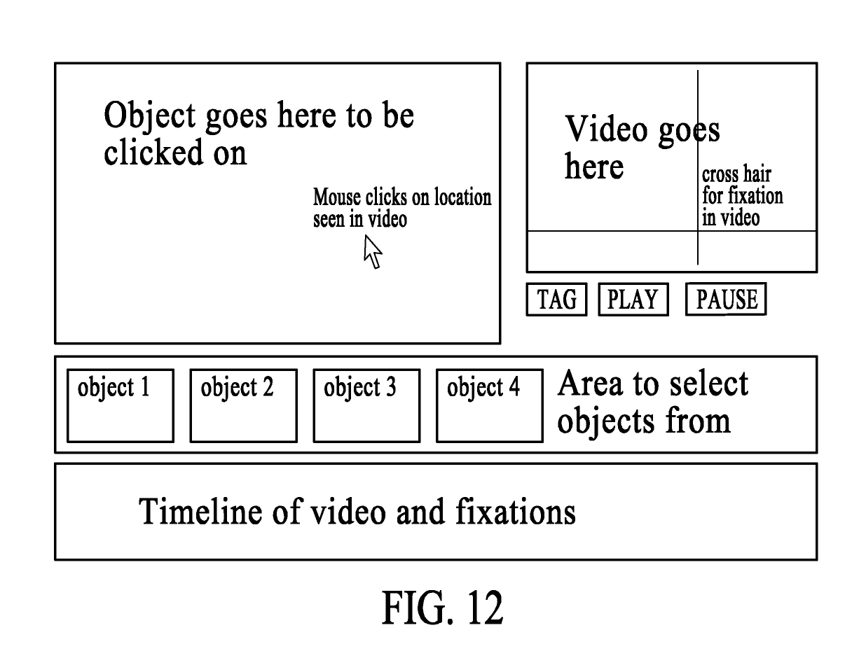

FIG. 12 shows an example user interface for tagging, under an embodiment. The upper left region or area of the interface shows the currently selected object that the tagger sees in the video. Objects can be selected from the list of pictures that represent them. Each time the tagger clicks on a location in the current object, the video jumps to the next fixation and draws a cross on the screen where the tagger should look to identify what the participant is viewing.

On each object, areas of interest can be identified that allow clicks from fixations to be grouped into clusters. This allows for the exact time a person looked at a part of an object to be identified and also correlated with other inputs such as physiological data or voice data. The neuromarketing processing system 100 of an embodiment includes an area of interest (AOI) component or system 104, running under and/or coupled to the processor, that performs the AOI design. Using the AOI system, the objects can be given attributes such as SKU number, price and others that can then be used in analysis, and this is stored in a database. The information can be combined with biometric measurement to know not only where the participant is looking, but how they are responding and feeling.

The AOI Designer receives a picture and outputs a list of named bounding boxes with positions in pixels defined by the user through clicking and dragging. Along with the AOI Designer, an Eye Tracking Tagger receives a video with a cross hair on it, a list of points in time of interest and a directory of pictures and lets the user select the picture and pixel location in the picture that is seen in the video at each point in time of interest. It outputs a predefined file format with picture name and pixel location for further analysis.

The AOI designer is used to define areas of interest (AOIs) in a picture that pertains to parts of a shelf in a store or parts of a billboard. Individual products on shelves will be defined as bounded areas so that they can be grouped later with eye tracking data that is recorded from participants to identify where they are looking.

The AOI Designer of an embodiment receives as input a .PNG file and outputs a .AOI file with the same name as the png and with content of .XML form. The AOI Designer Interface allows an operator to click and drag on a picture to create bounding areas with double click to edit their attributes.

The file attributes of the .AOI output file contents (XML) include, but are not limited to, the following: Project name; Shelf/Object outline color (R,G,B) to outline picture in analysis renderings; Name of shelf/billboard/sign/etc.; Real world width in meters of picture; Real world height in meters of picture; Real world location in store (X, Y of Lower left corner); Real world angle in store (0-360 degrees rotation); Picture Width, height to verify nothing has changed; Picture file name for future reference.

The AOI elements (between 10 and 500 will be in each file) of the .AOI output file contents (XML) include, but are not limited to, the following: Name of object (Package, element of sign, etc); Color of AOI (R,G,B) for human viewing; Ordered list of points that outline object in clockwise direction in pixel location from the upper left corner of the screen; Attributes—a string of name value pairs that the user can define during the project.

Actions of the AOI Designer of an embodiment are accessed via a menu. The menu of an embodiment provides access to one or more of the following actions, but the embodiment is not so limited:

File->New—New dialog to select the picture file and set attributes that will be saved in the .AOI file:
Picture name: XXX.png (No path)
Set all attributes in .AOI file
Picture is loaded for editing

File->Properties Shows all attributes of .AOI file again for editing.

File->Save (And save as)

File->Exit

View->AOI Names (Toggle if they are rendered)
If they are not rendered, the name of a focused on AOI should still be rendered, but no other ones should.

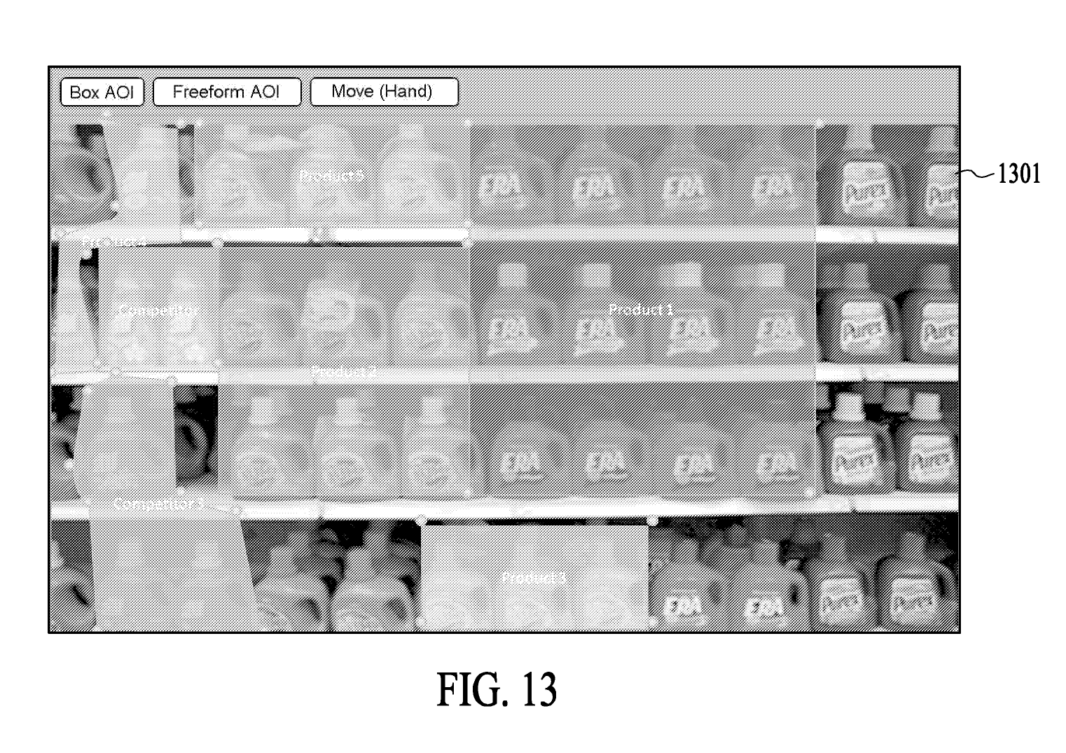

FIG. 13 is an example graphical user interface (GUI) of the AOI Designer, under an embodiment. The AOI Designer includes three modes, selected via the AOI GUI, but is not so limited. A user toggles between the three modes using three buttons in the tool bar. A Box AOI Creation mode involves the following, but is not so limited: Click and hold to create one corner of the box; Drag and then let go to create the other corner (coordinates are stored in a list of X,Y points with type BOX); Double click inside the area of the box to view the properties for the selected AOI; Click within 5 pixels of a corner to drag corner; Right click brings up menu with “Delete” and “Properties”.

A Freeform AOI Creation mode involves the following, but is not so limited: Select mode by clicking on toggle button; Click once to create first element; Click again and again to create the next segments of the line; Double click to close the shape; Rule of an embodiment is that no lines can intersect (should be a closed area without holes); Double click within the area to view attributes; Click within 5 pixels of a corner to drag corner; Right click on line segment and select “Split” to add a new node; Right click on corner point and select “delete” to delete a node.

A Navigation mode involves the following, but is not so limited: Use a scrollpane to allow movement around the editor; Scroll and CTRL+PLUS/MINUS to zoom; CTRL click drag to move around in a zoomed in area; Arrow keys to move around the zoomed in area; CTRL right click to zoom out fully.

Editing in the AOI Designer of an embodiment is supported if the user is in the box mode and clicks on the corner of a freeform AOI, or vise versa. In response, the mode should change between them automatically. If the user is in navigation mode, clicking on the corner of an AOI should not edit it, but double clicking on it should bring up the AOI's attributes.

When rendering the AOI, in the main view window of the application, the picture 1301 should be in the background, scaled appropriately with the ratio of height to width defined by the “Real World” dimensions, not the pixel height. Overlaid on the background picture is each of the AOIs (e.g., “Product 1”, “Product 2”, “Product 3”, “Product 4”, “Product 5”, “Competitor”, “Competitor 3”), with a semi transparent filled area. Multiple AOIs (e.g., “Product 4” and “Competitor”) can overlap, allowing an AOI to be a sub AOI of another one. When the mouse is over an AOI, the outline for the AOI should be drawn and each of the corners should be highlighted with a dot to show people where to click to edit the AOI. If multiple AOIs overlap, all of them should be highlighted. When the user clicks, the closest corner of an AOI (Within 5 pixels) should become active and should move when the mouse moves. Each time the AOI bounds are changed, the frame should be repainted so the motion is smooth. The Name of each AOI should be rendered in the center of the AOI.

As described above, the system of an embodiment include an Auto Event Tagger. The Auto Event Tagger application is used to make the process of identifying what participants are looking at more efficient. It takes in an event record file (.ero) with a list of pertinent AOI events which have been created by analyzing eye tracking data and identifying where a participant is looking at a specific area, not just moving his or her eyes around. These events have a start and stop time and other metadata. A video with a cross hair where the participant is looking will be used.

The Auto Event Tagger application will show a video, timeline and set of shelves and for each event in the ERO list, the video will advance to the correct point, the timeline will advance to the correct point and the last shelf that was selected will be put on screen. The user will then click on the pixel location in the picture of the shelf where the cross hair is in the video. This pixel location and the shelf name will be recorded in the .ero file and resaved. The user may also hit play on the video and as the video advances, the shelf and x,y location in the .ero file will be shown for each event at the corresponding time. The Auto Event Tagger replaces a very cumbersome process of identifying and tagging events by hand using drop down menus that may have up to 1000 elements if it is a large store.

Inputs of the Auto Event Tagger include the following, but are not so limited: Video file with a cross hair from the eye tracker; .ero file with a list of “AOI” events with start and stop times and with an empty field for description where we will store the shelf and location; Directory of .png picture files with corresponding .AOI files.

Outputs of the Auto Event Tagger include an .ero file with the description field of the “AOI” events filled in with “<SHELF>:X PIXEL,Y PIXEL, but are not so limited.

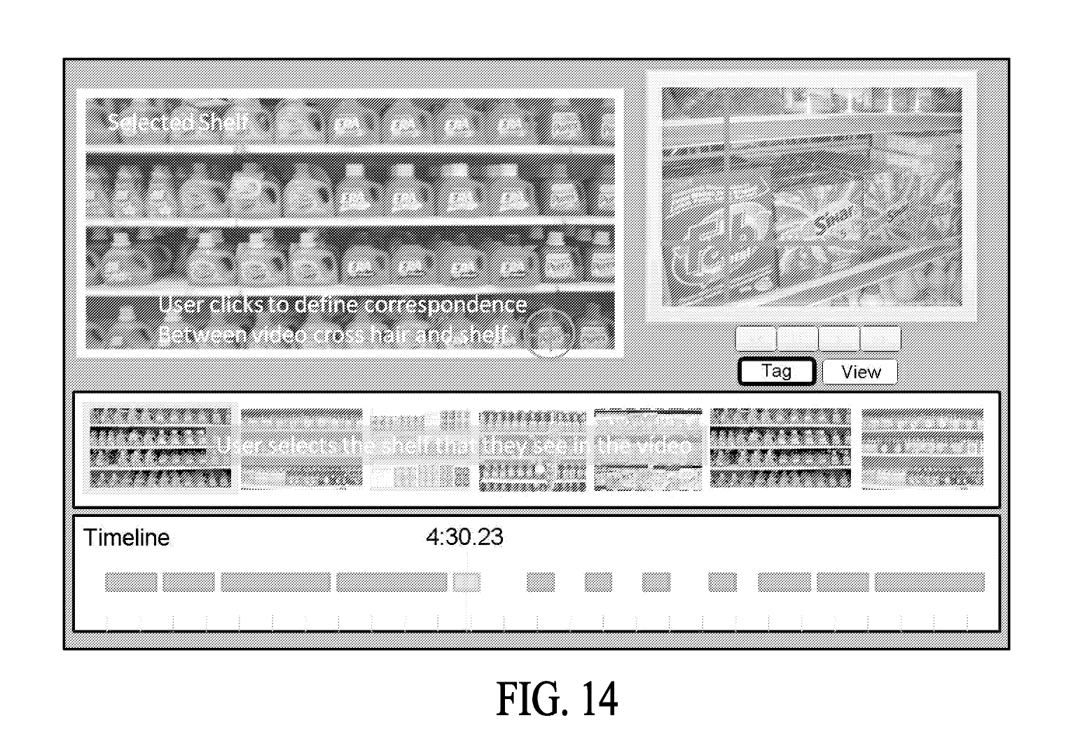

FIG. 14 is an example Auto Event Tagger graphical user interface (GUI), under an embodiment. The Auto Event Tagger includes two modes, a view mode and a tag mode. The view mode allows the user to click anywhere on the timeline and then play and pause the video. The selected shelf and the X,Y coordinate of the eye will change with each tagged shelf. The “Description” field will define which shelf name and which pixel location to put the cross hair at. This is a view to look at data and understand the data.

The tag mode is where the system automatically jumps forward (Video and timeline) to the next tag each time the user chooses a shelf and then clicks on the X,Y pixel coordinate that corresponds to the cross hair they see in the video. If the event has already been tagged, the old tag is shown and can be edited. A toggle should also be set that only iterates through non-tagged events or that iterates through all event—tagged and untagged. In tag mode, the buttons for the video are not enabled as they are enabled in the view mode.

The Auto Event Tagger enables or supports numerous actions. For example, the Auto Event Tagger enables a user to click on the timeline sets the video time to the selected time and updates the shelf If an event is present at that time, it sets the selected shelf and renders the X,Y location of the event.

The Auto Event Tagger enables a user to click play/pause/rewind/fast forward plays the video. Changes in the video location update the timeline and the shelf at somewhere around 10 Hz so the progression of eye movement can be seen.

Whenever the user clicks on the shelf, the selected event's focus point is put to this new point. This is true both in view and tag modes. The difference is that in view, the user can jump around, whereas in tag, the events are seen in order and the software jumps ahead to the next event each time the user clicks on the position for the current event.

The Auto Event Tagger enables a user to zoom on the timeline. Records will be from two minutes in length to one hour in length, so the user needs to be able to zoom in and out on the timeline.

If the video shows that the participant is not actually looking at any of the shelves, the user should click a button in the shelf area that say something like “No AOI”. This should set the description of the event to “NO AOI”.

### Purchase Clustering

Each in-store purchase is unique. Each purchase can be characterized in an embodiment using a set of attributes, for example: product purchased, motivation for purchase, difficulty of purchase decision, etc.

It is hypothesized herein that, when examining purchases across all these dimensions, the purchases might fall into groups or types. For example, the widely-used term “impulse buy” reflects a common experience of purchasing a non-essential item quickly, with little thought, perhaps while waiting in the checkout line, possibly evoking buyer's remorse upon leaving the store.

The Purchase Clustering efficiently and accurately characterizes different types of purchases in terms of observed behavior and measured bio-sensory responses.

Behavioral attributes may include, but are not limited to: Time elapsed from entering aisle/category to selecting item; Time spent looking at item before selecting the item; Time spent holding item before adding to cart.

Measured bio-sensory attributes may include, but are not limited to: Level/change of emotion/cognition as shopper enters aisle/category; Level/change of emotion/cognition as shopper scans aisle/category; Level/change of emotion/cognition as shopper evaluates products within aisle/category; and Level/change of emotion/cognition just before shopper selects item.

Other observed attributes may include, but are not limited to: Category of item; Brand of item; Price of item; Shopper demographics; Store environment.

Values are calculated for every attribute, for every purchase.

Statistical clustering techniques are used to define groups of purchases. A “group” is a set of purchases which are close in the multi-dimensional space described by all the attributes. “Closeness” is defined using a similarity measure, i.e. a function mapping two purchases' vectors of attributes to a single scalar reflecting the degree to which the two purchases are similar.

Groups are used to elucidate purchasing behavior.

### Scan Clustering

Each in-store Scan is unique. Each Scan is characterized using a set of attributes, for example: product scanned, motivation for scan, location of scan, timing of scan, length of scan, etc.

It is hypothesized that when examining scans across all these dimensions, the scans might fall into groups or types.

The Scan Clustering of an embodiment efficiently and accurately characterizes different types of scans in terms of observed behavior and measured bio-sensory responses.

Behavioral attributes may include, but are not limited to: Time elapsed from entering aisle/category to scanning item; Time spent scanning item.

Measured bio-sensory attributes may include, but are not limited to: Level/change of emotion/cognition as shopper enters aisle/category; Level/change of emotion/cognition as shopper enters aisle/category; Level/change of emotion/cognition as shopper scans aisle/category; Level/change of emotion/cognition as shopper evaluates/scans products after scanning a target product; Level/change of emotion/cognition just before shopper scans a product; and Level/change of emotion/cognition just after shopper scans a product.

Other observed attributes may include, but are not limited to: Category of item; Brand of item; Price of item; Shopper demographics; Store environment.

Values are calculated for every attribute, for every scan.

Statistical clustering techniques are used to define groups of purchases. A “group” is a set of scans which are close in the multi-dimensional space described by all the attributes. “Closeness” is defined using a similarity measure, i.e. a function mapping two scans' vectors of attributes to a single scalar reflecting the degree to which the two scans are similar.

Groups are used to elucidate scanning behavior.

### Bio-sensory Purchase Funnel

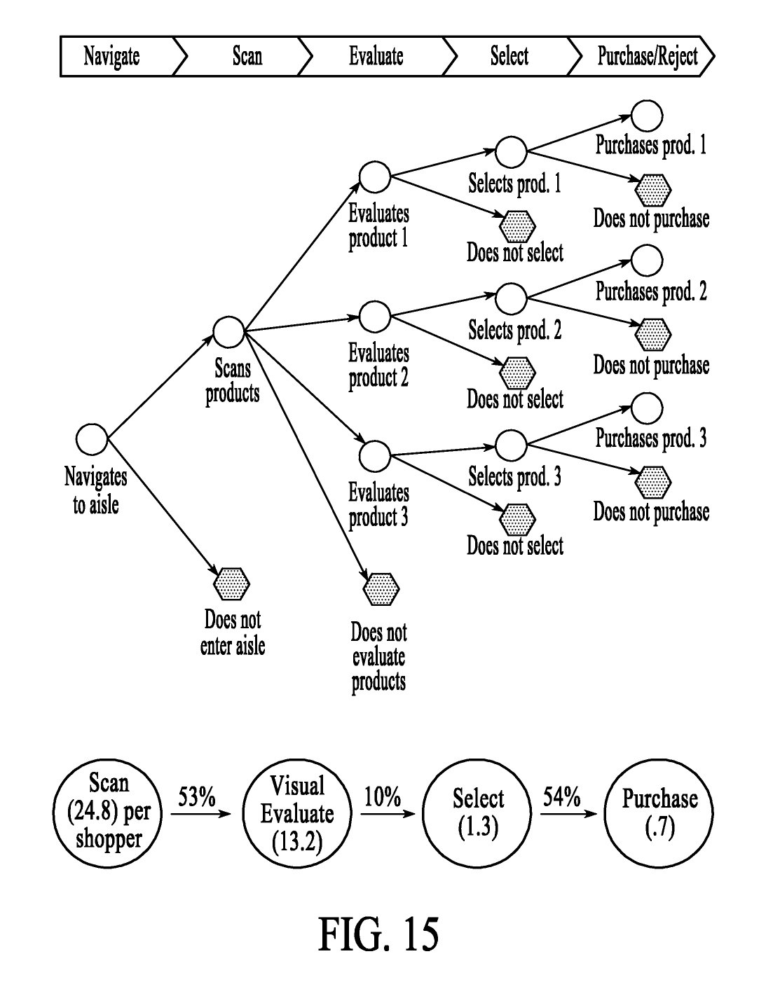

While shopping, several micro level decisions are made in the process leading up to a consumers purchase. Naturally, most products that are considered or looked at on a shopping trip are rejected and only a few are chosen for purchase. Using mobile eye tracking and biosensory data, an embodiment analyzes the way shoppers progress down the Purchase Funnel, by breaking down the decision process at the key points where decisions are made. An embodiment defines four stages of the shopper journey, but the embodiment is not so limited: Scan, Evaluate, Select, Purchase. The purchase funnel is defined as those who move from each of the following stages to the next. FIG. 15 is an example Purchase Funnel, under an embodiment.

The Purchase Funnel pinpoints and diagnoses why shoppers make decisions. Breaking down the purchase funnel based on fixations within a SKU and utilizing biosensory data on each step of the funnel provides an analysis of the effectiveness of a product on the shelf.

The Purchase Funnel defines and calculates each step or decision node in a shopper journey based on a unique combination of eye tracking and actions. The Purchase Funnel comprises navigation, which is the process of walking towards, or navigating to an aisle. The Purchase Funnel comprises scan, where scan is when the eye falls on a particular product (SKU) but does not fixate for more than a defined period of time (e.g., 0.5 seconds). The Purchase Funnel comprises evaluation, where evaluation is when the eye falls on a particular product (SKU) and fixates for a period of time greater than the defined period of time (e.g., 0.5 seconds). The Purchase Funnel comprises selection, where selection is when an individual picks up an item from the shelf.

Measured bio-sensory attributes of an embodiment include, but are not limited to level/change of emotion/cognition during, before, and after each of the nodes on the shopper journey described above. Measured non-bio-sensory actions of an embodiment include, but are not limited to, the number of shoppers that partake in each action, the number of times each node is encountered, and the percentage of actions that lead to the following action.

An embodiment algorithmically calculates values for every action and uses statistical techniques to verify the strength of the relationships against themselves, the norm, baseline or other values. An embodiment back tracks successful events to determine key relationships and correlations that lead to successful actions. Quantitative and qualitative reasons are identified why shoppers failed to progress forward at particular points in the decision profile. Data and results are used to elucidate purchasing behavior and product/brand/category effectiveness, and a database norm is generated to use for future reference at various product, category, brand & SKU levels.

### Bio Sensory and Eye Stop Hold Close Metrics

The strength of product packaging on the shelf has been previously defined by three factors: Stopping power (the ability of product packaging to Stop a person), Holding power (the ability of product packaging to attract the attention of a shopper, getting them to read a logo, etc) and Closing power (the ability of product packaging to generate a purchase). It is hypothesized herein that when examining these metrics, biosensory and eyetracking data would generate a more valuable and implementable set of metrics. An embodiment includes a novel technique of generating Bio Sensory Stop Hold Close metrics to efficiently and accurately determine the added value aspects of product packaging.

The generation of Bio Sensory Stop Hold Close metrics comprises collapsing data based on specific definitions relevant to shopper category (including separating any subgroups out). For example, the data is collapsed according to stopping poser, holding power, and closing power. The Stopping power information includes, but not limited to, the following: Percent Noting First in Category; Emotion During Noting; Cognition During Noting; Percent Evaluating (>0.5 sec); Additional Metrics; Percent Noting; Percent Noting in First 4 Seconds; Med Time to First Note; Percent Noting from >10 ft; Percent Noting from 2-10 ft; Percent Noting from <2 ft; Med Brands Noted Before Target.

The Holding power information includes, but not limited to, the following: Percent Re-evaluating; Total Time Evaluating; Emotion During Evaluation; Cognition During Evaluation; Percent Selecting; Med Time to First Evaluation; Time from First Note to First Evaluation; Evaluations per Shopper; Average Percentage Time Evaluate; Med Time to Select.

The Closing power information includes, but not limited to, the following: Emotion During Selection; Cognition During Selection; Percentage Placing in Basket; Additional Metrics; Median Time to Purchase (if purchase occurs); Time from Selection to Purchase.

The generation of Bio Sensory Stop Hold Close metrics comprises calculation of a category average and an overall score as well as an overall Stop, Hold and Close score based on deviations from the category average. The generation of Bio Sensory Stop Hold Close metrics comprises generation of actionable plans to improve overall performance on these metrics and in store. The generation of Bio Sensory Stop Hold Close metrics comprises use these scores to generate a database norm to use for future reference at various product, category, brand and SKU levels.

### Consideration Sets

Basket analysis discovers co-occurrence relationships among shoppers' purchases. Marketers have also tried to learn which items are being compared with their item on a competitive level while on the shelf. In order to answer this question, an embodiment uses eye tracking data and fixation length to determine the products considered with the target product. Associated Confidence intervals are generated to explore the different consideration sets with a target product based on, but not limited to, various fixation lengths, number of fixations, order of fixations, and time to fixations. Various breakouts and subgroup analysis have also been performed.

Generating consideration sets of an embodiment comprises recording and splitting fixations based on target product. Generating consideration sets of an embodiment comprises creating at least one threshold (fixation length, touching, holding, etc.) to define which products have been ‘considered’. Generating consideration sets of an embodiment comprises, if considering target product, generating information of how many and which other products were considered. Generating consideration sets of an embodiment comprises generating Association Confidence values that can be compared and ranked across products. Generating consideration sets of an embodiment comprises exploring any differences in these values or overall response by breaking out subgroups. Generating consideration sets of an embodiment comprises linking Consideration Set analysis to Basket analysis to determine the effectiveness of differing Consideration Sets.

Embodiments described herein include a method running on a processor for automatically segmenting video data of subjects, the method comprising capturing eye tracking data of subjects and identifying a plurality of gaze locations. The method of an embodiment comprises computing a gaze distance and a gaze velocity from the plurality of gaze locations. The method of an embodiment comprises identifying fixations. A fixation defines a region of interest (ROI). The method of an embodiment comprises automatically segmenting the eye tracking data by grouping continuous blocks of the fixations into ROI events.

Embodiments described herein include a method running on a processor for automatically segmenting video data of subjects, the method comprising: capturing eye tracking data of subjects and identifying a plurality of gaze locations; computing a gaze distance and a gaze velocity from the plurality of gaze locations; identifying fixations, wherein a fixation defines a region of interest (ROI); and automatically segmenting the eye tracking data by grouping continuous blocks of the fixations into ROI events.

The method of an embodiment comprises computing the gaze distance as a distance between consecutive gaze locations.

The gaze location of an embodiment is recorded as coordinate pairs in a machine-readable text file.

The gaze distance of an embodiment is distance between consecutive ones of the coordinate pairs corresponding to the gaze locations.

The method of an embodiment comprises computing the gaze velocity as a time derivative of the gaze distance.

The fixation of an embodiment is a period of time during which the gaze velocity is less than a threshold velocity.

The method of an embodiment comprises empirically setting the threshold velocity based on a distribution of the gaze distance.

The method of an embodiment comprises automatically segmenting the eye tracking data into ROIs based on eye tracking gaze velocity.

The method of an embodiment comprises correcting the gaze velocity for optical flow.

The eye tracking data of an embodiment is video, wherein the correcting comprises computing a cross correlation between consecutive frames of the video.

The computing of the cross correlation of an embodiment comprises computing the cross correlation in rectangular windows centered around coordinates of the gaze velocity.

The method of an embodiment comprises identifying a correlation peak coordinate as a coordinate of a global correlation maximum of the cross correlation.

The method of an embodiment comprises determining the optical flow as a vector distance between the correlation peak coordinate of the consecutive frames of the video.

The method of an embodiment comprises subtracting the optical flow from the gaze velocity.

The method of an embodiment comprises downsampling by a constant factor the frames of the video.

The method of an embodiment comprises during the determining of the optical flow, skipping at least one skipped frame. The method of an embodiment comprises filling in for the at least one skipped frame using linear interpolation.

The at least one skipped frame of an embodiment comprises a constant number of frames.

The method of an embodiment comprises writing the ROI events to an event file, and performing metadata tagging using contents of the event file.

The eye tracking data of an embodiment is market research video data of the subjects in an environment in which the subjects make purchasing decisions.

The performing of the metadata tagging of an embodiment includes use of location data of the subjects in the environment.

The performing of the metadata tagging of an embodiment includes use of body position data of the subjects in the environment.

The performing of the metadata tagging of an embodiment includes use of location data and body position data of the subjects in the environment.

The fixation of an embodiment is a period of time when visual attention of a subject is fixated on an object of a plurality of objects present in the environment.

The period of time of an embodiment exceeds approximately 100 milliseconds.

The method of an embodiment comprises generating a list of objects captured in the video data, wherein the list of objects comprises the plurality of objects.

The generating of the list of objects of an embodiment comprises generating a list of bounding boxes, wherein each bounding box has a position defined by pixels and corresponds to an object of the list of objects.

The method of an embodiment comprises, for each fixation, placing a marker in the video data, wherein the marker identifies a location in the environment where the subject is looking.

The method of an embodiment comprises selecting an object corresponding to the location in the environment where the subject is looking, wherein the list of objects comprises the object.

An object of the list of objects of an embodiment includes at least one of a product, a person, a shelf in the environment, and a floor layout in the environment.

Embodiments described herein include a method running on a processor and automatically segmenting data into regions of interest (ROIs), the method comprising capturing eye tracking data of subjects. The method of an embodiment comprises identifying a plurality of gaze locations from the eye tracking data. The method of an embodiment comprises computing a gaze distance as a distance between consecutive gaze locations. The method of an embodiment comprises computing a gaze velocity as a time derivative of the gaze distance. The method of an embodiment comprises identifying fixations. A fixation defines a ROI and is a period of time during which the gaze velocity is less than a threshold velocity. The method of an embodiment comprises automatically segmenting the eye tracking data into ROIs based on eye tracking gaze velocity by grouping continuous blocks of the fixations into ROI events.

Embodiments described herein include a method running on a processor and automatically segmenting data into regions of interest (ROIs), the method comprising: capturing eye tracking data of subjects; identifying a plurality of gaze locations from the eye tracking data; computing a gaze distance as a distance between consecutive gaze locations; computing a gaze velocity as a time derivative of the gaze distance; identifying fixations, wherein a fixation defines a ROI and is a period of time during which the gaze velocity is less than a threshold velocity; and automatically segmenting the eye tracking data into ROIs based on eye tracking gaze velocity by grouping continuous blocks of the fixations into ROI events.

Embodiments described herein include a method for processing video data running on a processor, the method comprising identifying a plurality of gaze locations from subjects of the video data. The method of an embodiment comprises computing a gaze distance and a gaze velocity from the plurality of gaze locations. The method of an embodiment comprises identifying fixations. A fixation is a period of time during which the gaze velocity is less than a threshold velocity. The method of an embodiment comprises generating a list of objects in the video data. Each object of the list of objects has a position defined by pixels. The method of an embodiment comprises placing a marker in the video data, for each fixation, wherein the marker identifies a location in the environment where a subject is looking. The method of an embodiment comprises selecting an object corresponding to the location in the environment where the subject is looking. The list of objects comprises the object.

Embodiments described herein include a method for processing video data running on a processor, the method comprising: identifying a plurality of gaze locations from subjects of the video data; computing a gaze distance and a gaze velocity from the plurality of gaze locations; identifying fixations, wherein a fixation is a period of time during which the gaze velocity is less than a threshold velocity; generating a list of objects in the video data, wherein each object of the list of objects has a position defined by pixels; placing a marker in the video data, for each fixation, wherein the marker identifies a location in the environment where a subject is looking; selecting an object corresponding to the location in the environment where the subject is looking, wherein the list of objects comprises the object.

Embodiments described herein include a system for processing video data of subjects, the system comprising at least one data collection device, and a processor coupled to the at least one data collection device. The processor receives bio-sensory data from the at least one data collection device. The bio-sensory data includes eye tracking data of subjects. The processor identifies a plurality of gaze locations from the eye tracking data. The processor computes a gaze distance and a gaze velocity from the plurality of gaze locations. The processor identifies fixations. A fixation defines a region of interest (ROI). The processor automatically segments the eye tracking data by grouping continuous blocks of the fixations into ROI events.

Embodiments described herein include a system for processing video data of subjects, the system comprising: at least one data collection device; a processor coupled to the at least one data collection device; wherein the processor receives bio-sensory data from the at least one data collection device, the bio-sensory data including eye tracking data of subjects; wherein the processor identifies a plurality of gaze locations from the eye tracking data; wherein the processor computes a gaze distance and a gaze velocity from the plurality of gaze locations; wherein the processor identifies fixations, wherein a fixation defines a region of interest (ROI); and wherein the processor automatically segments the eye tracking data by grouping continuous blocks of the fixations into ROI events.

The processor of an embodiment computes the gaze distance as a distance between consecutive gaze locations, wherein the gaze distance is distance between consecutive ones of the coordinate pairs corresponding to the gaze locations.

The processor of an embodiment computes the gaze velocity as a time derivative of the gaze distance, wherein the fixation is a period of time during which the gaze velocity is less than a threshold velocity.

The processor of an embodiment automatically segments the eye tracking data into ROIs based on eye tracking gaze velocity.

The processor of an embodiment corrects the gaze velocity for optical flow.

The eye tracking data of an embodiment is video, wherein the correcting comprises computing a cross correlation between consecutive frames of the video, wherein the computing of the cross correlation comprises computing the cross correlation in rectangular windows centered around coordinates of the gaze velocity.

The processor of an embodiment identifies a correlation peak coordinate as a coordinate of a global correlation maximum of the cross correlation.

The processor of an embodiment determines the optical flow as a vector distance between the correlation peak coordinate of the consecutive frames of the video.

The processor of an embodiment subtracts the optical flow from the gaze velocity.

The processor of an embodiment writes the ROI events to an event file and performs metadata tagging using contents of the event file.

The eye tracking data of an embodiment is market research video data of the subjects in an environment in which the subjects make purchasing decisions.

The performing of the metadata tagging of an embodiment includes use of at least one of location data and body position data of the subjects in the environment.

The fixation of an embodiment is a period of time when visual attention of a subject is fixated on an object of a plurality of objects present in the environment.

The processor of an embodiment generates a list of objects captured in the video data, wherein the list of objects comprises the plurality of objects.

The generating of the list of objects of an embodiment comprises generating a list of bounding boxes, wherein each bounding box has a position defined by pixels and corresponds to an object of the list of objects.

The processor of an embodiment, for each fixation, places a marker in the video data, wherein the marker identifies a location in the environment where the subject is looking.

The processor of an embodiment selects an object corresponding to the location in the environment where the subject is looking, wherein the list of objects comprises the object.

An object of the list of objects of an embodiment includes at least one of a product, a person, a shelf in the environment, and a floor layout in the environment.

Embodiments described herein include a system for processing bio-sensory data of subjects, the system comprising at least one data collection device, and a processor coupled to the at least one data collection device. The processor receives the bio-sensory data from the at least one data collection device. The processor identifies a plurality of gaze locations from the bio-sensory data and computes a gaze distance and a gaze velocity from the plurality of gaze locations. The processor identifies fixations. A fixation is a period of time during which the gaze velocity is less than a threshold velocity. The processor generates a list of objects in the video data. Each object of the list of objects has a position defined by pixels. The processor places a marker in the video data, for each fixation. The marker identifies a location in the environment where a subject is looking. The processor selects an object corresponding to the location in the environment where the subject is looking, wherein the list of objects comprises the object.

Embodiments described herein include a system for processing bio-sensory data of subjects, the system comprising: at least one data collection device; a processor coupled to the at least one data collection device, wherein the processor receives the bio-sensory data from the at least one data collection device; wherein the processor identifies a plurality of gaze locations from the bio-sensory data and computes a gaze distance and a gaze velocity from the plurality of gaze locations; wherein the processor identifies fixations, wherein a fixation is a period of time during which the gaze velocity is less than a threshold velocity; wherein the processor generates a list of objects in the video data, wherein each object of the list of objects has a position defined by pixels; wherein the processor places a marker in the video data, for each fixation, wherein the marker identifies a location in the environment where a subject is looking; and wherein the processor selects an object corresponding to the location in the environment where the subject is looking, wherein the list of objects comprises the object.

The components described herein can be components of a single system, multiple systems, and/or geographically separate systems. The components can also be subcomponents or subsystems of a single system, multiple systems, and/or geographically separate systems. The components can be coupled to one or more other components (not shown) of a host system or a system coupled to the host system.

The components of an embodiment include and/or run under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, cellular telephones, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components of the ECS, and/or provided by some combination of algorithms. The methods described herein can be implemented in one or more of software algorithm(s), programs, firmware, hardware, components, circuitry, in any combination.

The components can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the embodiments described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the embodiments include: microcontrollers with memory (such as electronically erasable programmable read only memory (EEPROM)), embedded microprocessors, firmware, software, etc. Furthermore, aspects of the embodiments may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments is not intended to be exhaustive or to limit the systems and methods to the precise forms disclosed. While specific embodiments of, and examples for, the embodiments are described herein for illustrative purposes, various equivalent modifications are possible within the scope of the systems and methods, as those skilled in the relevant art will recognize. The teachings of the embodiments provided herein can be applied to other systems and methods, not only for the systems and methods described above.

The elements and acts of the various embodiments described above can be combined to provide further embodiments. These and other changes can be made to the embodiments in light of the above detailed description.

In general, in the following claims, the terms used should not be construed to limit the embodiments to the specific embodiments disclosed in the specification and the claims, but should be construed to include all systems that operate under the claims. Accordingly, the embodiments are not limited by the disclosure, but instead the scope is to be determined entirely by the claims.

While certain aspects of the embodiments described herein are presented below in certain claim forms, the inventors contemplate the various aspects of the embodiments described above in any number of claim forms. Accordingly, the inventors reserve the right to add additional claims after filing the application to pursue such additional claim forms for other aspects of the embodiments described above.

What is claimed is:

1. A method running on a processor for automatically segmenting video data of subjects, the method comprising:
capturing eye tracking data of subjects and identifying a plurality of gaze locations;
computing a gaze distance and a gaze velocity from the plurality of gaze locations;
identifying fixations, wherein a fixation defines a region of interest (ROI); and
automatically segmenting the eye tracking data by grouping continuous blocks of the fixations into ROI events.

2. The method of claim 1, comprising computing the gaze distance as a distance between consecutive gaze locations.

3. The method of claim 2, wherein the gaze location is recorded as coordinate pairs in a machine-readable text file.

4. The method of claim 3, wherein the gaze distance is distance between consecutive ones of the coordinate pairs corresponding to the gaze locations.

5. The method of claim 1, comprising computing the gaze velocity as a time derivative of the gaze distance.

6. The method of claim 5, wherein the fixation is a period of time during which the gaze velocity is less than a threshold velocity.

7. The method of claim 6, comprising empirically setting the threshold velocity based on a distribution of the gaze distance.

8. The method of claim 1, comprising automatically segmenting the eye tracking data into ROIs based on eye tracking gaze velocity.

9. The method of claim 1, comprising correcting the gaze velocity for optical flow.

10. The method of claim 9, wherein the eye tracking data is video, wherein the correcting comprises computing a cross correlation between consecutive frames of the video.

11. The method of claim 10, wherein the computing of the cross correlation comprises computing the cross correlation in rectangular windows centered around coordinates of the gaze velocity.

12. The method of claim 10, comprising identifying a correlation peak coordinate as a coordinate of a global correlation maximum of the cross correlation.

13. The method of claim 12, comprising determining the optical flow as a vector distance between the correlation peak coordinate of the consecutive frames of the video.

14. The method of claim 13, comprising subtracting the optical flow from the gaze velocity.

15. The method of claim 14, comprising downsampling by a constant factor the frames of the video.

16. The method of claim 13, comprising:
during the determining of the optical flow, skipping at least one skipped frame;
filling in for the at least one skipped frame using linear interpolation.

17. The method of claim 16, wherein the at least one skipped frame comprises a constant number of frames.

18. The method of claim 1, comprising:
writing the ROI events to an event file; and
performing metadata tagging using contents of the event file.

19. The method of claim 18, wherein the eye tracking data is market research video data of the subjects in an environment in which the subjects make purchasing decisions.

20. The method of claim 19, wherein the performing of the metadata tagging includes use of location data of the subjects in the environment.

21. The method of claim 19, wherein the performing of the metadata tagging includes use of body position data of the subjects in the environment.

22. The method of claim 19, wherein the performing of the metadata tagging includes use of location data and body position data of the subjects in the environment.

23. The method of claim 19, wherein the fixation is a period of time when visual attention of a subject is fixated on an object of a plurality of objects present in the environment.

24. The method of claim 23, wherein the period of time exceeds approximately 100 milliseconds.

25. The method of claim 23, comprising generating a list of objects captured in the video data, wherein the list of objects comprises the plurality of objects.

26. The method of claim 25, wherein the generating of the list of objects comprises generating a list of bounding boxes, wherein each bounding box has a position defined by pixels and corresponds to an object of the list of objects.

27. The method of claim 25, comprising, for each fixation, placing a marker in the video data, wherein the marker identifies a location in the environment where the subject is looking.

28. The method of claim 27, comprising selecting an object corresponding to the location in the environment where the subject is looking, wherein the list of objects comprises the object.

29. The method of claim 25, wherein an object of the list of objects includes at least one of a product, a person, a shelf in the environment, and a floor layout in the environment.

30. A method running on a processor and automatically segmenting data into regions of interest (ROIs), the method comprising:
capturing eye tracking data of subjects;
identifying a plurality of gaze locations from the eye tracking data;
computing a gaze distance as a distance between consecutive gaze locations;
computing a gaze velocity as a time derivative of the gaze distance;
identifying fixations, wherein a fixation defines a ROI and is a period of time during which the gaze velocity is less than a threshold velocity; and
automatically segmenting the eye tracking data into ROIs based on eye tracking gaze velocity by grouping continuous blocks of the fixations into ROI events.

31. A method for processing video data running on a processor, the method comprising:
identifying a plurality of gaze locations from subjects of the video data;
computing a gaze distance and a gaze velocity from the plurality of gaze locations;
identifying fixations, wherein a fixation is a period of time during which the gaze velocity is less than a threshold velocity;
generating a list of objects in the video data, wherein each object of the list of objects has a position defined by pixels;
placing a marker in the video data, for each fixation, wherein the marker identifies a location in the environment where a subject is looking;
selecting an object corresponding to the location in the environment where the subject is looking, wherein the list of objects comprises the object.

32. A system for processing video data of subjects, the system comprising:
at least one data collection device;
a processor coupled to the at least one data collection device;
wherein the processor receives bio-sensory data from the at least one data collection device, the bio-sensory data including eye tracking data of subjects;
wherein the processor identifies a plurality of gaze locations from the eye tracking data;
wherein the processor computes a gaze distance and a gaze velocity from the plurality of gaze locations;
wherein the processor identifies fixations, wherein a fixation defines a region of interest (ROI); and
wherein the processor automatically segments the eye tracking data by grouping continuous blocks of the fixations into ROI events.

33. The system of claim 32, wherein the processor computes the gaze distance as a distance between consecutive gaze locations, wherein the gaze distance is distance between consecutive ones of the coordinate pairs corresponding to the gaze locations.

34. The system of claim 32, wherein the processor computes the gaze velocity as a time derivative of the gaze distance, wherein the fixation is a period of time during which the gaze velocity is less than a threshold velocity.

35. The system of claim 32, wherein the processor automatically segments the eye tracking data into ROIs based on eye tracking gaze velocity.

36. The system of claim 32, wherein the processor corrects the gaze velocity for optical flow.

37. The system of claim 36, wherein the eye tracking data is video, wherein the correcting comprises computing a cross correlation between consecutive frames of the video, wherein the computing of the cross correlation comprises computing the cross correlation in rectangular windows centered around coordinates of the gaze velocity.

38. The system of claim 37, wherein the processor identifies a correlation peak coordinate as a coordinate of a global correlation maximum of the cross correlation.

39. The system of claim 38, wherein the processor determines the optical flow as a vector distance between the correlation peak coordinate of the consecutive frames of the video.

40. The system of claim 39, wherein the processor subtracts the optical flow from the gaze velocity.

41. The system of claim 32, wherein the processor writes the ROI events to an event file and performs metadata tagging using contents of the event file.

42. The system of claim 41, wherein the eye tracking data is market research video data of the subjects in an environment in which the subjects make purchasing decisions.

43. The system of claim 42, wherein the performing of the metadata tagging includes use of at least one of location data and body position data of the subjects in the environment.

44. The system of claim 42, wherein the fixation is a period of time when visual attention of a subject is fixated on an object of a plurality of objects present in the environment.

45. The system of claim 44, wherein the processor generats a list of objects captured in the video data, wherein the list of objects comprises the plurality of objects.

46. The system of claim 45, wherein the generating of the list of objects comprises generating a list of bounding boxes, wherein each bounding box has a position defined by pixels and corresponds to an object of the list of objects.

47. The system of claim 45, wherein the processor, for each fixation, places a marker in the video data, wherein the marker identifies a location in the environment where the subject is looking.

48. The system of claim 47, wherein the processor selects an object corresponding to the location in the environment where the subject is looking, wherein the list of objects comprises the object.

49. The system of claim 45, wherein an object of the list of objects includes at least one of a product, a person, a shelf in the environment, and a floor layout in the environment.

50. A system for processing bio-sensory data of subjects, the system comprising:
at least one data collection device;
a processor coupled to the at least one data collection device, wherein the processor receives the bio-sensory data from the at least one data collection device;
wherein the processor identifies a plurality of gaze locations from the bio-sensory data and computes a gaze distance and a gaze velocity from the plurality of gaze locations;
wherein the processor identifies fixations, wherein a fixation is a period of time during which the gaze velocity is less than a threshold velocity;
wherein the processor generates a list of objects in the video data, wherein each object of the list of objects has a position defined by pixels;
wherein the processor places a marker in the video data, for each fixation, wherein the marker identifies a location in the environment where a subject is looking; and
wherein the processor selects an object corresponding to the location in the environment where the subject is looking, wherein the list of objects comprises the object.
